(19) United States
(12) Patent Application Publication
(10) Pub. No.: US 2022/0064976 A1
(43) Pub. Date: Mar. 3, 2022

(54) THERMAL-INSULATION COVER FOR ABOVE-GROUND POOL AND ABOVE-GROUND POOL

(71) Applicant: BESTWAY INFLATABLES & MATERIAL CORP., Shanghai (CN)

(72) Inventor: Shuiyong Huang, Shanghai (CN)

(21) Appl. No.: 17/404,914

(22) Filed: Aug. 17, 2021

(30) Foreign Application Priority Data
Aug. 27, 2020 (CN) 202021816743.3

(51) Int. Cl. E04H 4/00; E04H 4/08; B32B 5/18; B32B 15/20; B32B 5/02; B32B 27/30; B32B 7/09; B32B 27/06; B32B 15/082; B32B 27/12

(52) U.S. Cl. CPC E04H 4/0037; E04H 4/0025; E04H 4/08; B32B 5/18; B32B 15/20; B32B 5/02; B32B 2250/03; B32B 7/09; B32B 27/065; B32B 15/082; B32B 27/12; B32B 2307/304; B32B 2262/08; B32B 27/304

(57) ABSTRACT

A thermal-insulation cover for an above-ground pool is provided. The above-ground pool has a pool bottom and an outer wall coupled to the pool bottom. A thermal-insulation cover includes: a thermal-insulation sleeve configured to fit around the outer wall of the pool; and an extended portion including: an upper extension connected to an upper circumference of the thermal-insulation sleeve and extending radially inward from the upper circumference of the thermal-insulation sleeve, and a lower extension connected to a lower circumference of the thermal-insulation sleeve and extending radially inward from the lower circumference of the thermal-insulation sleeve.

### CROSS-REFERENCE TO RELATED APPLICATION

This application claims priority from Chinese patent Application CN202021816743.3 filed Aug. 27, 2020 in China, the disclosure of which is incorporated herein by reference in its entirety.

### BACKGROUND

### 1. Field

Apparatuses and methods consistent with exemplary embodiments relate to above-ground pools, and more specifically, to a thermal-insulation cover for an above-ground pool, and an above-ground pool comprising the thermal-insulation cover.

### 2. Description of the Related Art

Above-ground pools (such as an inflatable pools) are popular with consumers because they are easy to carry and install and are effective to use. Since an above-ground pool is usually used in an outdoor environment, pool pumps for such above-ground pools typically include a heater so that the pool water can be heated to a temperature suitable for a swimmer, particularly when the temperature is low outside. Additionally, certain above-ground pools include a thermal insulation lid and lid liner that cover the top of the pool body and are usually made of polyvinyl chloride (PVC). An above-ground pool may also include a thermal insulation ground mat, disposed under the pool, to increase the thermal insulation.

Unfortunately, such thermal insulation lids, lid liners, and ground mats have no specific insulation structure or insulation material, often resulting in poor thermal insulation, easy dissipation of heat, and high heating energy consumption. In particular, when a swimmer enters a pool, the thermal insulation lid and lid liner must be removed, necessarily reducing the insulation of the pool, and increasing heat loss and energy consumption.

### SUMMARY

Example embodiments may address at least the above problems and/or disadvantages and other disadvantages not described above. Also, example embodiments are not required to overcome the disadvantages described above, and may not overcome any of the problems described above.

One or more example embodiments may provide a new thermal-insulation cover for an above-ground pool, which thermal-insulation cover may improve the insulation effect of the above-ground pool and also provide energy conservation.

According to an aspect of an example embodiment, a cover for a pool comprises: a thermal-insulation sleeve configured to fit around an outer wall of the pool; and an extended portion, the extended portion comprising: an upper extension connected to an upper circumference of the thermal-insulation sleeve and extending radially inward from the upper circumference of the thermal-insulation sleeve; and a lower extension connected to a lower circumference of the thermal-insulation sleeve and extending radially inward from the lower circumference of the thermal-insulation sleeve.

The thermal-insulation sleeve may comprise: an inner layer; an outer layer connected to the inner layer at an upper edge of the inner layer and a lower edge of the inner layer, thereby defining an enclosed chamber between the inner layer and the outer layer; and an intermediate layer comprising a thermally-insulating material and disposed within the enclosed chamber.

A connection between the inner layer and the outer layer, between the sleeve and the upper extension portion, or between the sleeve and the lower extension portion may be at least one of a welded connection, a pasted connection, and a sewn connection.

The intermediate layer may comprise at least of foam, aluminum foil, sponge, and silk wadding.

The cover may further comprise at least one handle attached to an outer circumference of the thermal-insulation sleeve.

According to an aspect of another example embodiment, a pool comprises: a pool bottom and a pool wall; and a thermal-insulation cover comprising: a thermal-insulation sleeve configured to fit around the pool wall; and an extended portion, comprising: an upper extension connected to an upper circumference of the thermal-insulation sleeve and extending radially inward from the upper circumference of the thermal-insulation sleeve; and a lower extension connected to a lower circumference of the thermal-insulation sleeve and extending radially inward from the lower circumference of the thermal-insulation sleeve.

The pool may further comprise a thermal-insulation lid detachably connected to the thermal-insulation cover and configured to fit over a pool opening defined by a top of the pool wall.

The thermal-insulation cover may further comprise: a plurality of first fasteners disposed on an outside of the thermal-insulation sleeve, and the thermal-insulation lid comprising a plurality of second fasteners configured to attach with the plurality of first fasteners.

The pool may further comprise a lid liner attached to a bottom of the thermal-insulation lid and configured to fit over the pool opening.

The pool may be inflatable.

According to an aspect of another example embodiment, a pool cover may comprise: a sleeve having a substantially cylindrical shape configured to fit around an outer circumference of a pool, the sleeve comprising: an inner sheet; an outer sheet connected to the inner sheet such that an enclosed chamber is formed between the inner sheet and the outer sheet; and a thermally-insulating material disposed in the enclosed chamber; an upper extension extending radially inward from an upper circumference of the sleeve; and a lower extension extending radially inward from a lower circumference of the sleeve.

The enclosed chamber may extend around an entire circumference of the sleeve.

The thermally-insulating material may comprise at least one of foam, aluminum foil, sponge, and silk wadding.

The pool cover may further comprise: at least one handle attached to an outer surface of the outer sheet.

The at least one handle may comprise a plurality of handles evenly spaced around the outer surface of the outer sheet.

The pool cover may further comprise a lid detachably connected to one of the sleeve and the upper extension.

The lid may comprise a lid liner attached to a bottom of the lid.

The pool cover may further comprise at least one first fastener attached thereto, and the lid comprising at least one second fastener configured to detachably connect to the at least one first fastener.

A thermal-insulation cover for an above-ground pool, according to one or more example embodiments described herein may have a plurality of advantages, including, but not limited to: a reduction of the energy consumption of the above-ground pool while playing a good role in heat preservation. For example, in the heating process, the heating efficiency may be high, power consumption may be reduced, and during use, the heat loss may be less, and energy conservation and environmental protection may be achieved. According to one or more example embodiments, a thermal-insulation cover may have a simple structure and a low cost, be convenient to install and suitable for mass production, and may be widely used in any of various types of above-ground pools.

### BRIEF DESCRIPTION OF THE DRAWINGS

The above and/or other aspects and advantages will become apparent and more readily appreciated from the following description of example embodiments, taken in conjunction with the accompanying drawings in which:

FIG. 1 is a schematic diagram of an above-ground pool according to an example embodiment;

FIG. 2 is a partial exploded schematic diagram of the above-ground pool of FIG. 1, showing a thermal insulation lid, a lid liner, a pool body, and a thermal insulation cover, according to an example embodiment;

FIG. 3 is an exploded schematic diagram of the thermal-insulation cover of FIG. 2, according to an example embodiment; and

FIG. 4 is a cross-sectional schematic diagram of the thermal-insulation cover sleeved on the pool body of FIG. 2, according to an example embodiment.

### DETAILED DESCRIPTION

Reference will now be made in detail to exemplary embodiments which are illustrated in the accompanying drawings, wherein like reference numerals refer to like elements throughout. In this regard, the exemplary embodiments may have different forms and may not be construed as being limited to the descriptions set forth herein.

It will be understood that the terms “include,” “including,” “comprise,” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be further understood that, although the terms “first,” “second,” “third,” etc., may be used herein to describe various elements, components, regions, layers and/or sections, these elements, components, regions, layers and/or sections may not be limited by these terms. These terms are only used to distinguish one element, component, region, layer or section from another element, component, region, layer or section.

As used herein, the term “and/or” includes any and all combinations of one or more of the associated listed items. Expressions such as “at least one of,” when preceding a list of elements, modify the entire list of elements and do not modify the individual elements of the list. In addition, the terms such as “unit,” “-er (-or),” and “module” described in the specification refer to an element for performing at least one function or operation, and may be implemented in hardware, software, or the combination of hardware and software.

As used herein, directional terms such as “top” and “bottom” are all defined according to the directions in which an above-ground pool is normally used, as shown in the drawings.

Various terms are used to refer to particular system components. Different companies may refer to a component by different names—this document does not intend to distinguish between components that differ in name but not function.

Matters of these example embodiments that are obvious to those of ordinary skill in the technical field to which these exemplary embodiments pertain may not be described here in detail.

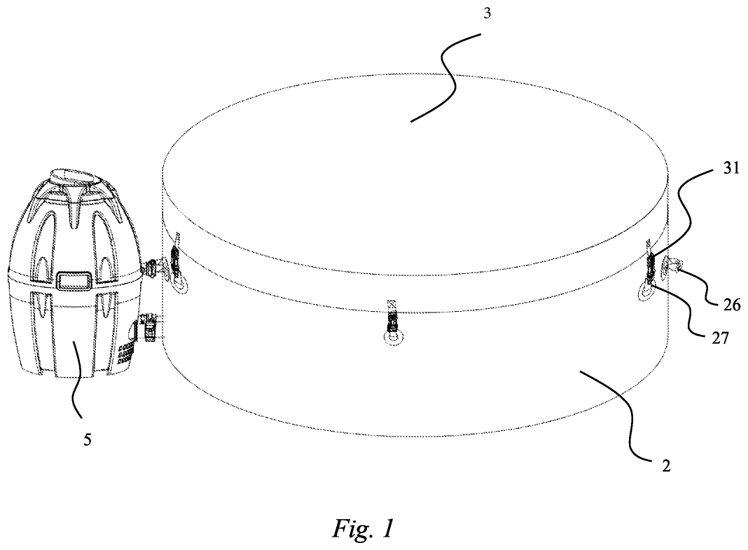

FIGS. 1 through 4 illustrate an above-ground pool and its thermal-insulation cover according to example embodiments. It is noted that the above-ground pool illustrated in the figures and described herein is an inflatable pool. However, example embodiments are not limited to an inflatable pool, and a thermal-insulation cover according to one or more examples can also be applied to any other type of above-ground pool, such as a frame pool, as would be understood by one of skill in the art.

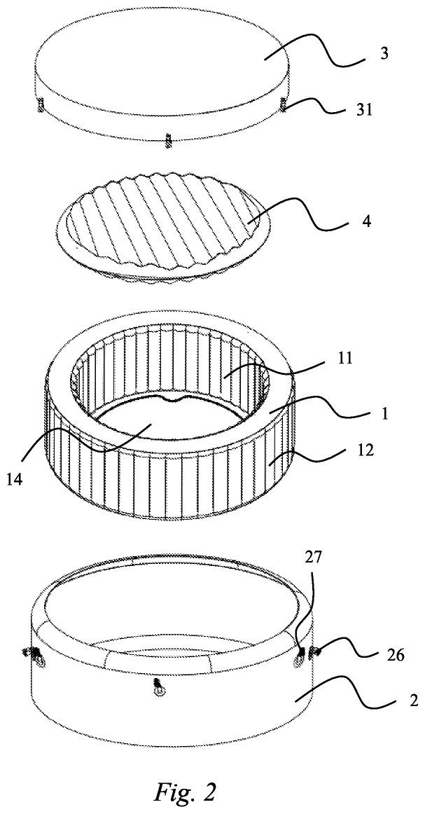

As shown in FIGS. 1 and 2, an inflatable pool includes a pool body 1, a pool pump 5, and a thermal-insulation structure detachably fixed to a periphery of the pool body 1.

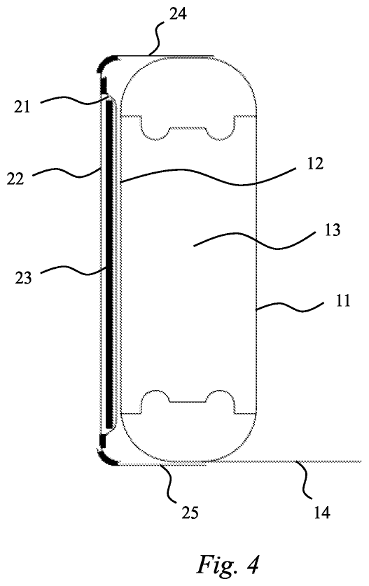

The pool body 1 includes a pool bottom 14 and an inflatable pool wall coupled to the pool bottom 14. The pool bottom 14 may be formed of a PVC sheet material. If an insulation effect of the pool bottom 14 needs to be increased, the bottom 14 may be designed as a dual layer structure, including one or more insulation materials disposed between the two sheets. For example, one or more insulation materials such as foam, aluminum foil, sponge, and silk wadding may be disposed between two PVC sheets of the bottom 14. The inflatable pool wall includes, for example, an inner wall 11, formed of the PVC sheet material, an outer wall 12, and a plurality of tension bands 13, as shown in FIG. 4; a top edge of the inner wall 11 is connected to a top edge of the outer wall 12, and a bottom edge of the inner wall 11 is connected to a bottom edge of the outer wall 12, thereby defining an inflatable chamber therebetween. The tension bands 13 are connected to the inner wall 11 and the outer wall 12 to tension the inflatable chamber, thereby preventing excessive expansion of the chamber. The inner wall 11 and the pool bottom 14 define a water injection chamber suitable for containing water.

The pool pump 5 may include a filter pump, used to filter impurities from the water, and a gas pump used to inject gas into the water in a water injection chamber, in order to provide a wave function and a massage function. The filter pump provides water circulation by means of a water inlet pipeline and a water outlet pipeline, which are connected to the filter pump and which pass through the inflatable pool wall, and by means of the water injection chamber. The gas pump supplies gas to the water injection chamber by means of a gas inlet pipeline, which is connected to the gas pump and which also passes through the inflatable pool wall.

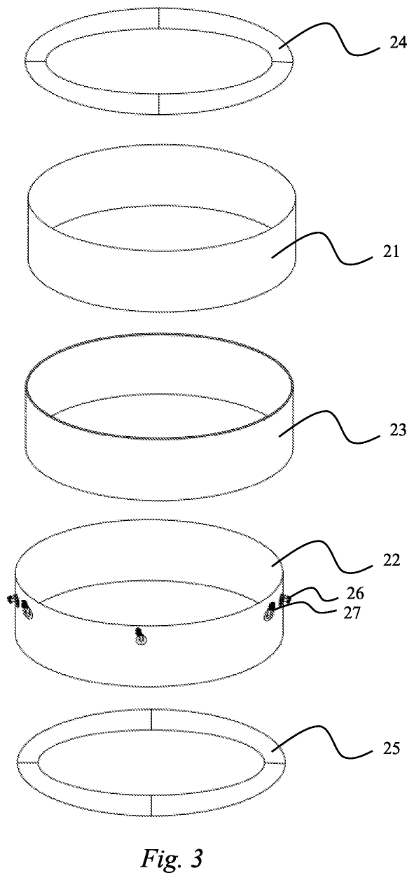

According to an example embodiment, the thermal-insulation structure of the inflatable pool comprises a thermal-insulation cover 2. As shown in FIGS. 3 and 4, the thermal-insulation cover 2 includes an thermal-insulation portion and an extended portion, wherein the thermal-insulation portion is configured to be disposed at a periphery of the pool wall, forming a sleeve around the pool wall, in order to prevent heat loss therefrom. The extended portion is connected to the thermal-insulation portion and is configured to be in contact with the top and the bottom of the inflatable pool wall.

The thermal-insulation portion may include, for example, an inner layer 21 formed of the PVC sheet material, an outer layer 22, and an intermediate layer 23 made of a thermal-insulation material and arranged between the inner layer 21 and the outer layer 22. The top of the inner layer 21 is connected to the top of the outer layer 22, and the bottom of the inner layer 21 is connected to the bottom of the outer layer 22, so as to define an enclosed chamber between the inner layer 21 and the outer layer 22, the enclosed chamber being suitable to be filled with the intermediate layer 23. The intermediate layer 23 may be made of any kind of collapsible thermal-insulation material or materials, such as any one or more of foam, aluminum foil, sponge, silk wadding, and any other material as would be understood by one of skill in the art. The extended portion comprises an upper part 24 and a lower part 25 which are made of the PVC sheet material. The upper part 24 is annular, and is connected to the top of the thermal-insulation portion and is provided to cover the top of the inflatable pool wall. The lower part 25 is also annular, and is connected to the bottom of the thermal-insulation portion and is provided around the pool bottom 14 and at the bottom of the inflatable pool wall. When the thermal-insulation cover 2 is disposed around the inflatable pool wall, and a user wants to move the inflatable pool, due to the support provided to the inflatable pool wall by the lower part 25 of the thermal-insulation cover, the pool body 1 is retained within the bottom of the thermal-insulation cover 2. The inner layer 21 and the outer layer 22 may be connected to each other, for example, by means of at least one of welding, pasting or other adhering, and sewing. The upper part 24 and one or more of the inner layer 21, the outer layer 22, and the intermediate layer 23 may be connected to each other, for example, by means of at least one of welding, pasting or other adhering, and sewing. The lower part 25 and one or more of the inner layer 21, the outer layer 22, and the intermediate layer 23 may be connected to each other, for example, by means of at least one of welding, pasting or other adhering, and sewing.

As shown in FIGS. 1-3, the thermal-insulation cover 2 may further include at least one handle 26 arranged on an outside thereof, for example on an outer surface of the outer layer 22, so that a user may move the inflatable pool when the thermal-insulation cover 2 is disposed therearound. The thermal-insulation cover 2 may include a plurality of handles 26 arranged on an outer surface of the outer layer 22. Such a plurality of handles 26 may be uniformly spaced around a circumference of the thermal-insulation cover 2.

According to one or more example embodiments, when the thermal-insulation cover 2 is disposed around the periphery of the inflatable pool wall of the pool body 1, since the thermal-insulation cover 2 includes a thermal-insulation material layer (e.g. the intermediate layer 23), heat loss from the inflatable pool may be reduced and energy consumption may be reduced. In addition, the thermal-insulation cover 2 does not entirely cover a pool opening defined by the top of the inflatable pool wall, and thus, a user can access the inflatable pool without removing the thermal-insulation cover 2. In this way, the heat preservation and energy saving effect of the thermal-insulation cover 2 is not affected during the use of the inflatable pool.

The thermal-insulation cover 2 can also work in cooperation with a thermal-insulation lid, so that both the top and the sides of the inflatable pool are covered by a thermal-insulation layer to further reduce heat loss, and energy consumption can be further reduced in the process of heating and heat preservation of the inflatable pool.

As shown in FIGS. 1 and 2, the thermal-insulation structure of the inflatable pool may further include a thermal-insulation lid 3 which is detachably connectable to the thermal-insulation cover 2 to fit over the pool opening defined by the top of the inflatable pool wall. The thermal-insulation cover 2 may include a plurality of first fasteners 27, which may be uniformly arranged around an outer circumference of the cover 2, such as being arranged on the outer surface of the outer layer 22. The thermal-insulation lid 3 may also include a plurality of second fasteners 31, which may be uniformly arranged around an outer circumference of the lid 3, to be connectable to the first fasteners 27. For example, the first fasteners 27 and the second fasteners 31 may connect to each other in a clamping manner. Of course, the connection method between the thermal-insulation lid 3 and the thermal-insulation cover 2 is not limited to this clamping fit between the first and second fasteners 27 and 31. It should be understood that the thermal-insulation lid 3 and the thermal-insulation cover 2 may be connected to each other by means of any convenient detachable fixing method, such as zipper fit, mushroom buckle fit, or another means that would be understood by one of skill in the art.

As shown in FIG. 2, the inflatable pool may also include a lid liner 4 which is fixedly attached or is attachable to the bottom of the thermal-insulation lid 3 to cover the pool opening, so as to further improve the insulation effect of the inflatable pool. The lid liner 4 may be an inflatable structure, for example, and may be attached to the thermal-insulation lid 3 by means of a connecting structure fixed to the thermal-insulation top lid 3.

It may be understood that the exemplary embodiments described herein may be considered in a descriptive sense only and not for purposes of limitation. Descriptions of features or aspects within each exemplary embodiment may be considered as available for other similar features or aspects in other exemplary embodiments.

While exemplary embodiments have been described with reference to the figures, it will be understood by those of ordinary skill in the art that various changes in form and details may be made therein without departing from the spirit and scope as defined by the following claims.

What is claimed is:

1. A cover for a pool, the cover comprising:
a thermal-insulation sleeve configured to fit around an outer wall of the pool; and
an extended portion, comprising:
an upper extension connected to an upper circumference of the thermal-insulation sleeve and extending radially inward from the upper circumference of the thermal-insulation sleeve; and
a lower extension connected to a lower circumference of the thermal-insulation sleeve and extending radially inward from the lower circumference of the thermal-insulation sleeve.

2. The cover according to claim 1, the thermal-insulation sleeve comprising:
an inner layer;
an outer layer connected to the inner layer at an upper edge of the inner layer and a lower edge of the inner layer, thereby defining an enclosed chamber between the inner layer and the outer layer; and
an intermediate layer comprising a thermally-insulating material and disposed within the enclosed chamber.

3. The cover according to claim 2, wherein a connection between the inner layer and the outer layer, between the sleeve and the upper extension portion, or between the sleeve and the lower extension portion is at least one of a welded connection, a pasted connection, and a sewn connection.

4. The cover according to claim 2, wherein the intermediate layer comprises at least of foam, aluminum foil, sponge, and silk wadding.

5. The cover according to claim 1, further comprises at least one handle attached to an outer circumference of the thermal-insulation sleeve.

6. A pool, comprising:
a pool bottom and a pool wall; and
a thermal-insulation cover comprising:
a thermal-insulation sleeve configured to fit around the pool wall; and
an extended portion, comprising:
an upper extension connected to an upper circumference of the thermal-insulation sleeve and extending radially inward from the upper circumference of the thermal-insulation sleeve; and
a lower extension connected to a lower circumference of the thermal-insulation sleeve and extending radially inward from the lower circumference of the thermal-insulation sleeve.

7. The pool according to claim 6, further comprising:
a thermal-insulation lid detachably connected to the thermal-insulation cover and configured to fit over a pool opening defined by a top of the pool wall.

8. The pool according to claim 7, the thermal-insulation cover further comprising:
a plurality of first fasteners disposed on an outside of the thermal-insulation sleeve, and
the thermal-insulation lid comprising a plurality of second fasteners configured to attach with the plurality of first fasteners.

9. The pool according to claim 7, further comprising a lid liner attached to a bottom of the thermal-insulation lid and configured to fit over the pool opening.

10. The pool according to claim 6, wherein the pool is inflatable.

11. A pool cover comprising:
a sleeve having a substantially cylindrical shape configured to fit around an outer circumference of a pool, the sleeve comprising:
an inner sheet,
an outer sheet connected to the inner sheet such that an enclosed chamber is formed between the inner sheet and the outer sheet; and
a thermally-insulating material disposed in the enclosed chamber;
an upper extension extending radially inward from an upper circumference of the sleeve; and
a lower extension extending radially inward from a lower circumference of the sleeve.

12. The pool cover according to claim 11, the enclosed chamber extending around an entire circumference of the sleeve.

13. The pool cover according to claim 12, the thermally-insulating material comprising at least one of foam, aluminum foil, sponge, and silk wadding.

14. The pool cover according to claim 11, further comprising:
at least one handle attached to an outer surface of the outer sheet.

15. The pool cover according to claim 14, the at least one handle comprising a plurality of handles evenly spaced around the outer surface of the outer sheet.

16. The pool cover according to claim 11, further comprising:
a lid detachably connected to one of the sleeve and the upper extension.

17. The pool cover according to claim 16 the lid comprising a lid liner attached to a bottom of the lid.

18. The pool cover according to claim 16, further comprising at least one first fastener attached thereto, and the lid comprising at least one second fastener configured to detachably connect to the at least one first fastener.
